(19) United States
(12) Patent Application Publication
(10) Pub. No.: US 2010/0002479 A1
(43) Pub. Date: Jan. 7, 2010

(54) Power supply device with power factor correction and (startup) current limitation

(75) Inventor: Wolfgang Wagner, Friedrichshafen (DE)

Correspondence Address: POSZ LAW GROUP, PLC, 12040 SOUTH LAKES DRIVE, SUITE 101, RESTON, VA, 20191, US

(73) Assignee: Recaro Aircraft Seating GmbH & Co., KG, Schwabisg Hall (DE)

(21) Appl. No.: 12/311,178

(22) PCT Filed: Aug. 31, 2007
(86) PCT No.: PCT/EP2007/007607

§ 371 Date: Mar. 20, 2009

(30) Foreign Application Priority Data
Sep. 22, 2006 (DE) 102006044879.0

(51) Int. Cl. H02M 7/00

(52) U.S. Cl. 363/73

(57) ABSTRACT

A power supply device, particularly for an airplane, has a control unit that is provided to match a current path to a voltage curve. An embodiment relates to a rectifier with power factor correction in the form of a step-up converter with switchable (startup) current limitation.

### CROSS REFERENCE TO RELATED APPLICATIONS

This application is a U.S. national stage application of PCT/EP2007/007607 filed on Aug. 31, 2007, and claims priority to, and incorporates by reference, German Patent Application No. 10 2006 044 879.0 filed on Sep. 22, 2006.

### BACKGROUND

The invention is based on a power supply apparatus.

Power supply apparatuses, particularly for application in aircraft, are already known which have a regulatory unit and which are provided for the purpose of aligning a current profile with a voltage profile.

### SUMMARY

The invention is based on a power supply apparatus, particularly for an aircraft, having a regulatory unit which is provided for the purpose of aligning a current profile with a voltage profile. In this context, “aligning” is to be understood to mean particularly at least approximating the voltage profile to the current profile.

It is proposed that the power supply unit have at least one active unit having at least one connectable unit. In this context, an “active unit” is to be understood to mean particularly a unit which is provided for the purpose of at least semi-automatically implementing a switching operation. In addition, the “connectable unit” is intended to be understood to mean particularly a unit which can be used to influence the current profile in an operating range. Undesirable differences between the current profile and the voltage profile despite the regulation by the regulatory unit can therefore advantageously be at least counteracted. Furthermore, it is possible to achieve filtering in a further frequency range, particularly between 350-800 Hz, a distortion factor can be improved and it is possible to attain advantageous limiting for an inrush current.

If the active unit is provided for the purpose of connecting the unit in the range of a zero crossing in the voltage profile, it is possible to at least reduce difference errors particularly in the range of the zero point in the voltage profile or at the zero crossing. In this case, “range of a zero crossing in the voltage profile” is intended to be understood to mean particularly a range below 30%, preferably below 20% and particularly advantageously below 15% of the maximum applied voltage.

The unit may be formed by various units which appear appropriate to a person skilled in the art, particularly advantageously by a unit which has an at least essentially linear response in at least one operating range, preferably at a zero crossing of the voltage, “essentially” being intended to be understood to mean particularly that the response thereof differs from a theoretically fully linear response by less than 10%.

In addition, the unit is particularly advantageously formed by a resistor unit, a “resistor unit” being intended to be understood to mean particularly a unit which is provided for the purpose of simulating an ohmic resistor at a zero crossing in at least one operating range, such as a field-effect transistor, and/or preferably has at least one ohmic resistor, which means that the resistor unit is simple to implement particularly in design terms. A resistor unit can advantageously easily be used to achieve the filtering in a further frequency range, to improve the distortion factor, and it is possible to attain advantageous limiting of an inrush current, specifically particularly by virtue of it being possible to dispense with an input resistor for the regulatory unit or to at least reduce the resistance value of said input resistor.

If the unit has, at least in one range, at least one parameter which is dependent on a temperature value in order to achieve a specific temperature response, it is advantageously possible to achieve desired automatic adjustment to a varying temperature value, and advantageous linearization over the load can be attained. “Specific temperature response” is in this case intended to be understood to mean particularly that the unit is chosen specifically such that its response changes with the temperature value.

Particularly advantageously, the unit has an NTC (Negative Temperature Coefficient) response, so that as the temperature rises a parameter falls, such as advantageously an electrical resistance, which means that increased safety can be achieved. To attain the NTC response, the unit may have various components which appear suitable to a person skilled in the art, but the unit advantageously has at least one NTC resistor, which allows an appropriate response to be implemented easily and inexpensively in design terms.

In a further refinement of the invention, it is proposed that the active unit have at least one control unit which is provided for the purpose of initiating a switching operation at least at a particular phase angle, which means that interference effects occurring at particular phase angles can be counteracted specifically. In this case, the control unit may be formed by various units which appear appropriate to a person skilled in the art, such as particularly by phase angle comparators and/or by units which switch at particular times, for which there are particular phase angles, etc. A switching threshold may be coupled to a phase and/or to an amplitude.

Preferably, the active unit has at least one comparator, which means that a desired switching operation, particularly at a particular phase angle, can be achieved specifically, in a manner which is simple in design terms.

### BRIEF DESCRIPTION OF THE DRAWINGS

Further advantages can be found in the description of the drawing which follows. The drawing shows an exemplary embodiment of the invention. The drawing, the description and the claims contain numerous features in combination. A person skilled in the art will expediently also consider the features individually and combine them to form appropriate further combinations.

In the drawing,

FIG. 1 shows a schematic illustration of a power supply apparatus according to the invention, and

FIG. 2 shows a voltage profile.

### DETAILED DESCRIPTION

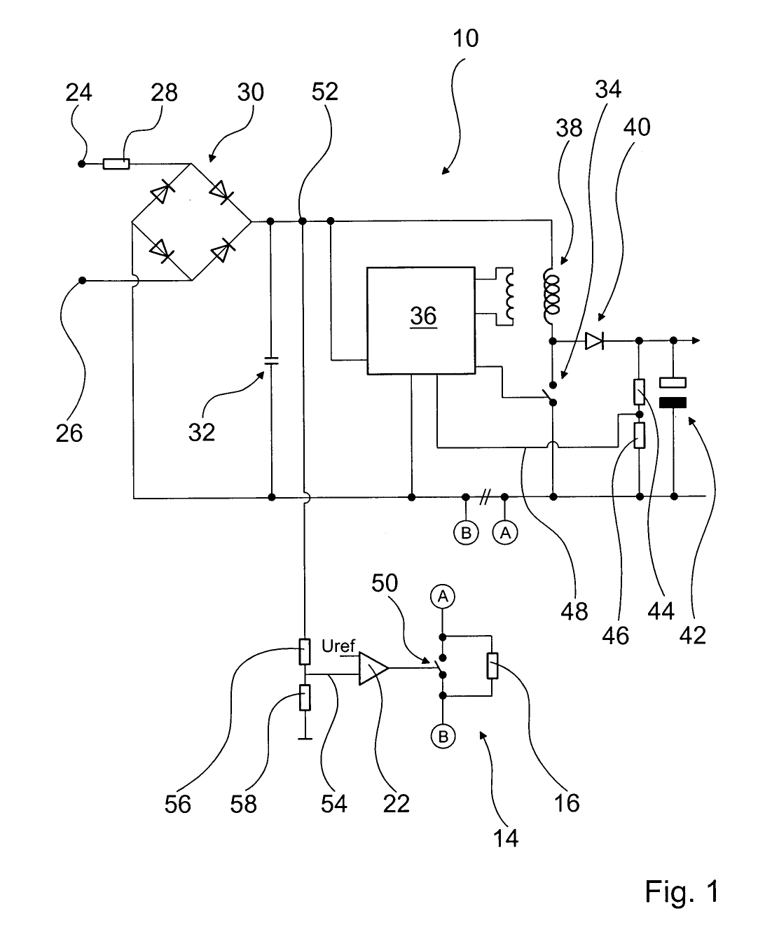

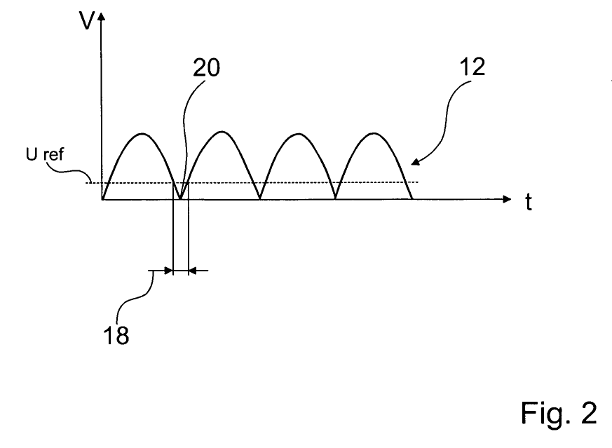

FIG. 1 shows a schematically illustrated power supply apparatus for an aircraft having a regulatory unit 10 which is provided for the purpose of aligning a current profile with a voltage profile 12 (FIGS. 1 and 2). The regulatory unit 10 is connected to an AC (Alternating Current) current source—not shown in more detail—by means of the connections 24, 26 and, following the connection, has an NTC resistor 28 in order to limit an inrush current. The NTC resistor 28 is followed by a bridge rectifier 30 in the regulatory unit 10. In addition, the regulatory unit 10 comprises a buffer capacitor 32 for a switch 34 in the regulatory unit 10, said switch being switched by a PFC (Power Factor Correction) chip 36 in the regulatory unit 10. In addition, the regulatory unit 10 has an electronic unit 38 which is coupled to the PFC chip 36 and has an inductor and an auxiliary coil for storing energy, a diode 40 for rectification which is connected downstream of the electronic unit 38, and a capacitor 42 which is connected downstream of the diode 40. In addition, the regulatory unit 10 has resistors 44, 46 for voltage feedback which are connected downstream of the diode 40 and in parallel with the capacitor 42, with a path 48 coupled between the resistors 44, 46 being routed to the PFC chip 36. The task of the regulatory unit 10 is to produce a current which follows the sinusoidal shape of the voltage as exactly as possible. This applies both to the sinusoidal shape of the current and to the phase between current and voltage. This means that the regulatory unit 10 is provided for the purpose of more or less simulating a resistive load.

Besides the regulatory unit 10, the power supply apparatus has an active unit 14 having a connectable unit 16 which is formed by an ohmic NCT resistor. The active unit 14 is connected downstream of the switch 34 in series at the docking points identified by A and B or is integrated into the current path of the switch 34. Referring to FIGS. 1 and 2, the active unit 14 has a control unit 22 which is formed by a comparator and which is provided for the purpose of comparing a voltage applied downstream of the bridge rectifier 30 with a reference voltage U_{ref} which is between 5% and 15%, preferably approximately 10%, of the maximum voltage or approximately 15 V, and hence connecting the unit 16 in a range 18 of a zero crossing 20 in the voltage profile 12 by means of a switch 50 at a particular phase angle. Starting from a connection 52 downstream of the bridge rectifier 30, a path 54 to the control unit 22 has a resistor 56 connected upstream of it and a resistor 58 connected downstream of it, the second resistor 58 being grounded.

Above the reference voltage U_{ref}, the switch 50 is closed. Once the reference voltage U_{ref} is undershot, the control unit 22 opens the switch 50 and the current from the switch 34, which is controlled by the PFC chip 36, flows via the unit 16, and this affects the clock frequency of the PFC chip 36 by virtue of a soft characteristic curve being achieved and the clock frequency being lowered as a result. In addition, the connection affects the sinusoidal current of the asynchronous generator by virtue of an actual ohmic resistor being present. When the sinusoidal input voltage rises above the reference voltage U_{ref} again, the unit 16 is shorted by the switch 50 again and is therefore inoperative.

When the AC current source is switched on or when the system is started up, the switch 50 is open. The current accordingly flows through the unit 16 formed by the NTC resistor and is limited to a known value. After a certain time when the system has been initiated, the switch 50 closes and the unit 16 formed by the NTC resistor is shorted. At this time, the capacitor 42 holds a charge and, without the active unit 14 and without the NTC resistor 28, would have resulted in a high inrush current, so that the deactivation of the unit 16 formed by the NTC resistor has no consequences. As a result of the active unit 14, the NTC resistor 28 can advantageously be provided with small dimensions or even eliminated completely, which means that losses and resultant heating can at least be reduced.

The design of the unit 16 as an NTC resistor means that malfunctions and overheating can be avoided in the event of the switch 50 failing.

1. A power supply apparatus, particularly for an aircraft, having a regulatory unit which is provided for the purpose of aligning a current profile with a voltage profile, the power supply apparatus comprising:
at least one active unit having at least one connectable unit.

2. The power supply apparatus as claimed in claim 1,
wherein
the active unit is provided for the purpose of connecting the unit in a range of a zero crossing in the voltage profile.

3. The power supply apparatus as claimed in claim 1,
wherein
the connectable unit is formed by a resistor unit.

4. The power supply apparatus as claimed in claim 3,
wherein
the unit has at least one ohmic resistor.

5. The power supply apparatus as claimed in claim 1,
wherein
the unit has, at least in one range, at least one parameter which is dependent on a temperature value in order to achieve a specific temperature response.

6. The power supply apparatus as claimed in claim 5,
wherein
the unit has an NTC response.

7. The power supply apparatus as claimed in claim 1,
wherein
the active unit has at least one control unit which is provided for the purpose of initiating a switching operation at least at a particular phase angle.

8. The power supply apparatus as claimed in claim 1,
wherein
the active unit comprises at least one comparator.

9. A method for aligning a current profile with a voltage profile using a regulatory unit, particularly for application in an aircraft,
wherein
a unit is connected in the range of a zero crossing.

10. The method as claimed in claim 9,
wherein
a resistor unit is connected.
